(19) United States
(12) Patent Application Publication
(10) Pub. No.: US 2015/0133161 A1
(43) Pub. Date: May 14, 2015

(54) METHOD FOR REQUESTING INFORMATION BASED ON LOCATION

(71) Applicant: Davis B. Ray, Decatur, GA (US)

(72) Inventor: Davis B. Ray, Decatur, GA (US)

(21) Appl. No.: 14/078,411

(22) Filed: Nov. 12, 2013

(51) Int. Cl. H04W 4/02

(52) U.S. Cl. CPC H04W 4/02
USPC 455/456.3

(57) ABSTRACT

A method for requesting information is based on using a user's physical location to access a database of available information linked to that location. The method gives the user a single interaction to capture exactly what they intended. In addition, the method allows the user to retain the original intent and to gather further information and details, either immediately or at a later time. The users are able to get information they desire without having to rely on their memory and without being distracted to write or type something down. The method can rely on an electronic device's global positioning system (GPS) to provide a simple method to permit a user to, with a single input, capture the GPS location and, either immediately or at some point in the future, access any data or information linked to that location.

### BACKGROUND OF THE INVENTION

The present invention relates to information request methods and, more particularly, to a method for an individual to request information from an entity based on their longitude and latitude location.

Messages or similar items seen as a person passes can be difficult to recall later. Many times, when passing by something they wish to remember, a person cannot write a note down, type into a device (which may be illegal when driving, for example), or take a photograph (which requires a line of sight and can also be distracting). Trying to remember the item they wish to remember can often prove futile, as the memory can be lost or the item not recalled.

One solution to this problem has been the ever-increasing use of quick response (QR) codes, where a user can scan the code to get more information about a product, service or the like. However, the use of QR codes requires very close proximity to capture.

As can be seen, there is a need for a method for requesting additional information based on the physical location of a user.

### SUMMARY OF THE INVENTION

In one aspect of the present invention, a method for requesting information based on a user's location comprises running an application on a mobile electronic device; invoking the application at a location having an item for which a user desires additional information; sending the user's location data to a database; matching the user's location data with advertiser information stored in the database; and returning advertiser information to the mobile electronic device.

In another aspect of the present invention, a method for requesting information based on a user's location comprises running an application on a mobile electronic device; invoking the application at a location having an item for which a user desires additional information; storing the user's location locally on the mobile electronic device for later submission to the database when a data connection is not available; sending the user's location data to a database when the data connection is available; matching the user's location data with advertiser information stored in the database; returning advertiser information to the mobile electronic device; and displaying to the user a list of matches.

These and other features, aspects and advantages of the present invention will become better understood with reference to the following drawings, description and claims.

### BRIEF DESCRIPTION OF THE DRAWINGS

FIG. 1 is a flow chart describing a method for requesting information based on user location according to an exemplary embodiment of the present invention; and

FIG. 2 is a continuation of the flow chart of FIG. 1, describing an exemplary method for requesting information based on user location.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a method for requesting information based on a user's physical location. The method gives the user a single interaction to capture exactly what they intended. In addition, the method allows the user to retain the original intent and to gather further information and details, either immediately or at a later time. The users are able to get information they desire without having to rely on their memory and without being distracted to write or type something down. The method can rely on an electronic device's global positioning system (GPS) to provide a simple method to permit a user to, with a single input, capture the GPS location and, either immediately or at some point in the future, access any data or information linked to that location.

The technology of grabbing a user's current location is easy and fairly reliable from many sources. For example, smart phones will be required to have GPS by 2016 as mandated by 911 emergency services. Additionally, more and more vehicles have in-dash GPS. These systems or other such electronic devices with built-in GPS will be able to use the methods of the present invention to gather information based on the user's location.

The present invention, broadly, involves accessing the GPS location of the user and sending these coordinates to a web server. In turn, the web server can return information this is rich with information about the item seen. If, by chance, no data is available for a particular location, the location information can be logged for future reference by the user.

The user can invoke the methods of the present invention in a simple and convenient manner. For example, the user can push a button on their smart phone or vehicle dashboard. In some embodiments, the user can speak into the smart phone or a car navigation system to invoke the method and log the user's current location. The location data is pushed to a database where content is returned based on what the advertiser has supplied.

The methods of the present invention can be, for example, implemented with an application of code (java, C+, or the like) on the phone or navigation system that captures the latitude and longitude and sends it to the web server database where data is stored. Based on, for example, Geo Fence, the coordinates match within a range of coordinates that an advertiser has purchased to enact data files.

For example, driving by a car dealer, a consumer can press the button to invoke the method of the present invention. The consumer is then presented with choices to call the dealer, hear current lease specials, hear other specials, or the like. If passing a billboard, the user can select a similar action and can be present with choices such as playing an audio file, getting additional information in print form, or the like. In some embodiments, the user can store the information for later access and retrieval. In some embodiments, the user can be provided with rich media that can be reviewed later via the internet or other devices, or on the application itself.

The application can be installed on a portable electronic device, such as a smart phone, navigation system, tablet computer, or the like. The application can be mapped to a web service database that can receive the user's geo code and present one or more choices based on the area congestion. Options can be provided, as described above, to call the advertiser, call a number for pre-recorded additional information, map to the location, play audio files, display video files, display coupons and specials, and the like. The advertiser can control the data files and can be provided with a web-based interface to choose what to present.

Typically, an advertiser can be provided with coordinates (latitudes and longitudes, typically a specific range of coordinates that define a given area) that are reserved to them for a particular product or service. In some embodiments, the coordinates can overlap between multiple advertisers.

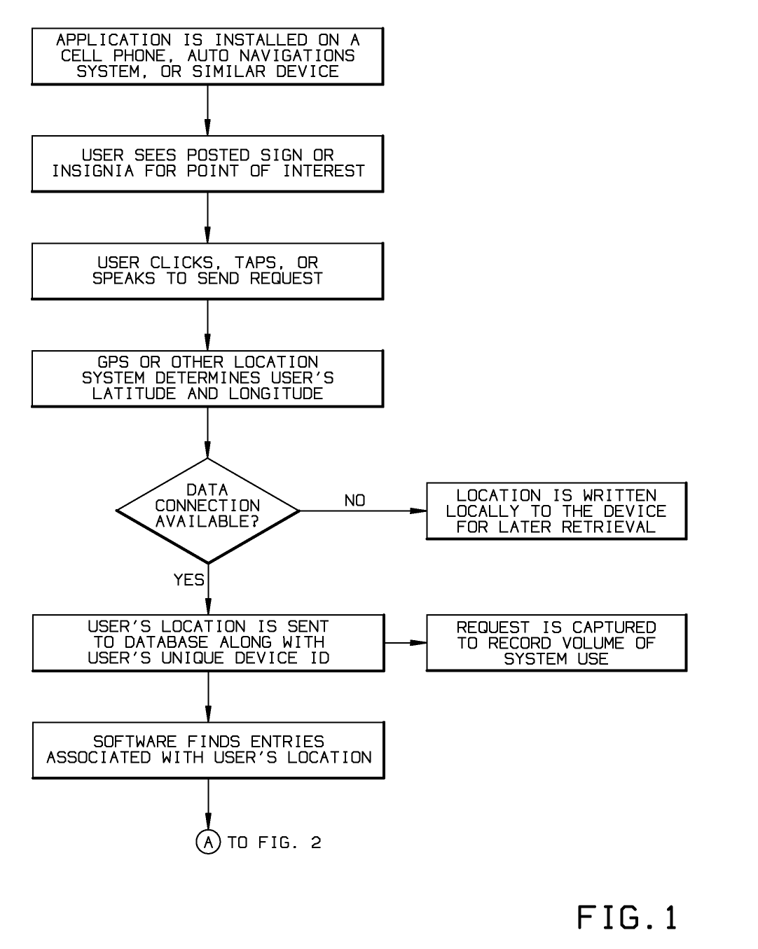

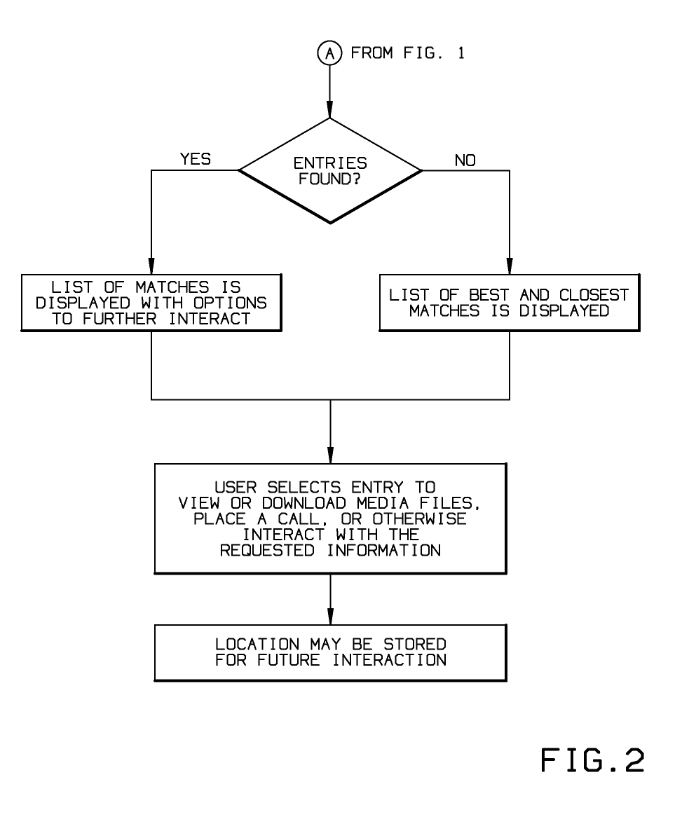

Referring to FIGS. 1 and 2, exemplary steps in a method according to the present invention are presented. Once the application is installed, the user can invoke the application when they see a posted sign or insignia that peaks their interest. Various methods can be used to invoke the system. For example, the user can click on an icon, tap the screen, speak to the device, or the like.

Once invokes, the application can capture the user's current latitude and longitude coordinates through a GPS or other location detection system. If a data connection is available, the user's location is sent to a database, along with the user's unique device ID. If no data connection is available, the location can be written locally to memory in the device for later retrieval.

The database can compare the user's coordinates with entries associated with that location. If entries are found, a list of matches is displayed to the user with options for further interaction. If no entries are found, a list of best and closest matches can be displayed.

A user can select an entry to view or download media files, place a call, or otherwise interact with the requested information. The user's location can be stored for future interaction.

In addition to the requested information, as discussed above, the methods of the present invention can provide users with traffic alerts, construction alerts, public service announcements, disabled assistance calls, weather alerts, audience notifications, and the like.

It should be understood, of course, that the foregoing relates to exemplary embodiments of the invention and that modifications may be made without departing from the spirit and scope of the invention as set forth in the following claims.

What is claimed is:

1. A method for requesting information based on a user's location, comprising:
running an application on a mobile electronic device;
invoking the application at a location having an item for which a user desires additional information;
sending the user's location data to a database;
matching the user's location data with advertiser information stored in the database; and
returning advertiser information to the mobile electronic device.

2. The method of claim 1, further comprising clicking, tapping or speaking to the mobile electronic device to invoke the application.

3. The method of claim 1, storing the user's location locally on the mobile electronic device for later submission to the database when a data connection is not available.

4. The method of claim 1, wherein the mobile electronic device is selected from a smart phone and a vehicle navigation system.

5. The method of claim 1, further comprising displaying to the user a list of matches.

6. The method of claim 5, further comprising selecting one item from the list of matches to gather additional information thereabout.

7. The method of claim 1, further comprising storing the location data for future interaction.

8. The method of claim 1, further comprising capturing the user's location sent to the database to track system use volume.

9. A method for requesting information based on a user's location, comprising:
running an application on a mobile electronic device;
invoking the application at a location having an item for which a user desires additional information;
storing the user's location locally on the mobile electronic device for later submission to the database when a data connection is not available;
sending the user's location data to a database when the data connection is available;
matching the user's location data with advertiser information stored in the database;
returning advertiser information to the mobile electronic device; and
displaying to the user a list of matches.

10. The method of claim 9, further comprising storing the location data for future interaction.
